(19) United States
(12) Patent Application Publication
(10) Pub. No.: US 2004/0257561 A1
(43) Pub. Date: Dec. 23, 2004

(54) Apparatus and method for sampling

(76) Inventors: Takao Nakagawa, Tokyo (JP); Toshiyuki Fuyuki, Tokyo (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 10/837,641

(22) Filed: May 4, 2004

Related U.S. Application Data
(63) Continuation-in-part of application No. 09/862,700, filed on May 22, 2001, now abandoned.

(30) Foreign Application Priority Data
Nov. 24, 2000 (JP) 2000-358471

(51) Int. Cl. G01N 21/01

(52) U.S. Cl. 356/244

(57) ABSTRACT

A sampling apparatus of a minute sample for a microscopic analysis includes a frame fixed at a prescribed position relative to the object lens of an optical microscope; a moving member supported with the frame so as to be reciprocatably movable between a sampling position and a waiting position; a member for holding the moving member at the waiting position; and a device for adjusting the position of a sampling needle relative to the moving member whereby the tip of the sampling needle is situated at focus position of the object lens when the moving member is moved to the sampling position. The sampling needle is adjustable relative to the moving member.

### TECHNICAL FIELD

The present invention relates to an apparatus and a method for collecting a minute sample to inspect or analyze the sample by using various inspecting apparatuses or analyzing apparatuses. More specifically, the present invention relates to an apparatus which is used in combination with an optical microscope for collecting a minute, fine, or microscopic sample, and relates to a sampling method using the apparatus.

Thus, the sampling apparatus of the present invention is used, for instance, for collecting a dust or foreign substance attached to the surface of silicon wafers (semiconductor wafers) used for producing integrated circuits (IC) and others. For the purpose of the present invention, the term “attached” includes the meaning of “very weakly adhered” and “settled”.

### BACKGROUND ART

In order to inspect and analyze a dust or foreign substance attached to the surface of a semiconductor wafer or the like, (a) apparatuses for collecting the dust or foreign substance (sample for microscopic analysis) attached to the surface of a semiconductor wafer or the like and (b) apparatuses for inspecting and analyzing the collected dust or foreign substance to find its component have heretofore been used.

Conventional sampling apparatuses in this field are constructed with their optical microscope portion and sampling portion being integrated. When the conventional apparatuses were used and the surface of a semiconductor wafer was observed with the optical microscope portion to find a dust or foreign substance, a sampling needle of the sampling portion is used to be moved by operating a joy stick or the like to bring the tip of the sampling needle close to or to make the tip of the needle contact with the dust or foreign substance (sample for microscopic analysis) thereby to catch the dust or foreign substance by the tip of the sampling needle.

However, conventional sampling apparatuses require skill of a person who practices the sampling, because when conventional apparatuses are used, sampling of a dust or foreign substance (sample for microscopic analysis) is performed by moving a sampling needle while observing the dust or foreign substance through a microscope after the person discovered the dust or foreign substance on the surface of a semiconductor wafer.

Besides, it was impossible to install only a sampling portion of conventional sampling apparatuses to other ordinary microscopes and conduct a sampling since conventional sampling apparatuses are constructed with their optical microscope portion and a sampling portion being integrated.

Accordingly, conventional sampling apparatuses were expensive, and it was impossible for people who did not have a sampling apparatus to readily conduct a sampling even when they had an optical microscope.

### DISCLOSURE OF THE INVENTION

Considering the situations described above, objects of the present invention are

(001) to make it possible to readily collect a minute sample for microscopic analysis,

(002) to provide a sampling apparatus having a simple structure and being low in its cost, and to provide a sampling method in which sampling operations are simple, and

(003) to provide a sampling apparatus which can be used by detachably install it to an ordinary microscope.

In order to achieve the objects of the present invention described above, a sampling apparatus of the present invention comprises

(A01) a frame fixed at a prescribed position relative to the object lens of an optical microscope,

(A02) a moving member supported with the fixed frame so as to be reciprocatably movable between a sampling position and a waiting position,

(A03) a member for holding the moving member at the waiting position,

(A04) a device for adjusting the position of a sampling needle relative to the moving member so that the tip of the sampling needle is situated at the focus position of the object lens of the optical microscope (hereinafter, sometimes, the words “the object lens of” are omitted for brevity) in the state wherein the moving member was moved to the sampling position, and

(A05) means for fixing the sampling needle to the moving member in the state wherein the position of the sampling needle relative to the moving member was adjusted so that the tip of the sampling needle is situated at the focus position of the optical microscope.

Also, in order to achieve the objects of the present invention, a sampling method of the present invention comprises conducting the following steps (B01) to (B03) in order:

(B01) a sample moving step in which the surface to which a sample to be inspected or analyzed is attached is moved, preferably together with the sample stage which supports the surface, so that the sample is moved to the focus position of an optical microscope,

(B02) a needle moving step in which a moving member, which supports a sampling needle and is moved integratedly with the sampling needle, is moved from a waiting position where the position of the tip of the sampling needle is apart from the focus position of an optical microscope to a sampling position where the tip 6f the sampling needle is situated at the focus position of the optical-microscope, and

(B03) a sampling step in which a sample is caught on the tip of the sampling needle and taken away from the surface to collect

by using a sampling apparatus in which a moving member, which supports a sampling needle and is moved integratedly with the sampling needle, is adjusted so as to be reciprocatably movable between a waiting position where the position of the tip of the sampling needle is apart from the focus position of an optical microscope and a sampling position where the tip of the sampling needle is situated at the focus position of the optical microscope.

### BRIEF DESCRIPTION OF THE DRAWINGS

FIGS. 1A to 1C are illustrations of the entire sampling apparatus U of the present invention described in Example 1. FIG. 1A is the plane view of the sampling apparatus, FIG. 1B is the cross-sectional side view of the apparatus taken along line IB-IB in FIG. 1A, and FIG. 1C is the view of the apparatus viewed from the direction of arrow 1C in FIG. 1B.

FIGS. 2A to 2C are illustrations of the frame to be fixed in the sampling apparatus shown in FIG. 1. FIG. 2A is the plane view of the frame, FIG. 2B is the view of the frame viewed from the direction of arrow IIB in FIG. 2A, and FIG. 2C is the view of the frame viewed from the direction of arrow IIC in FIG. 2A.

FIGS. 3A and 3B are illustrations of the upper plate of the sampling apparatus U. FIG. 3A is the plane view of the plate and FIG. 3B is the view of the plate viewed from the direction of arrow 111B in FIG. 3A.

FIGS. 4A and 4B are illustrations of the side plate fixed to the right side surface of a pair of protruded portions 3a, 3a (shown in FIGS. 2A and 2C) of the sampling apparatus U. FIG. 4A is the front view of the plate and FIG. 4B is the view of the plate viewed from the direction of arrow IVB in FIG. 4A.

FIGS. 5A and 5B are illustrations of the slider in sampling apparatus U. FIG. 5A is the plane view of the slider and FIG. 5B is the view of the slider viewed from the direction of arrow VB in FIG. 5A.

FIGS. 6A and 6B are illustration of the shaft in the sampling apparatus U. FIG. 6A is the front view of the shaft and FIG. 6B is the bottom view of the shaft viewed from the direction of arrow VIB in FIG. 6A.

FIG. 7 is a cross-sectional view of a spring case in the sampling apparatus U.

FIG. 8 is an exploded view of a needle holder and sampling needle.

FIG. 9 is a view showing the state wherein a moving member was moved from the position shown in FIG. 1B to a lower position.

FIGS. 10A and 10B are illustrations of the sampling apparatus U of the present invention described in Example 2. FIG. 10A is a view showing the state wherein moving member 15 of the sampling apparatus U is held at a waiting position and FIG. 10B is a view showing the state wherein the moving member 15 was moved to a sampling position.

FIGS. 11A and 11C are illustrations of the sampling apparatus U of the present invention described in Example 3. FIG. 11A is a view showing the state wherein moving member 15 of the sampling apparatus U is held at a waiting position, and FIG. 11C is a view showing the state wherein the moving member 15 was moved to a sampling position. FIG. 11B is the cross-sectional view of an important part of the moving member described in Example 3 taken along the line XIB-XIB in FIG. 11A.

In these Figures, M designates an optical microscope, 1: a flame to be fixed, 15: a moving member, 17: a member (a compression spring) for holding a moving member at a waiting position, 23: a sampling needle, 24: means for fixing a sampling needle (a fixing screw), and (11e, 21, 22): an apparatus for adjusting needle position.

### BEST MODE FOR CARRYING OUT THE INVENTION

In order to facilitate comparison between this section and Examples below, the same referential numeral or symbol as used in the Examples is added to the member or portion corresponding to the member or portion described in the Examples, with the numeral or symbol being parenthesized. This is to facilitate understanding of the present invention and not to limit the scope of the present invention.

Sampling Apparatus:

In a sampling apparatus of the present invention constructed as described above, a frame (1) is fixed at a prescribed position relative to the object lens of an optical microscope (M). The fixed frame (1) supports a moving member (15) so as to be reciprocatably movable between a sampling position and a waiting position. A member (17) for holding the moving member (15) holds the member at a waiting position.

Position of a sampling needle (23) relative to the moving member (15) can be adjusted with a device (11e, 21, 22) used for adjusting a needle position so that the tip of the sampling needle (23) is situated at the focus position of the optical microscope (M) in the state wherein the moving member (15) was moved to a sampling position.

Means (24) used for fixing a sampling needle fixes the sampling needle (23) to the moving member (15) in the state wherein the position of the sampling needle (23) relative to the moving member (15) was adjusted so that the tip of the sampling needle (23) is situated at the focus position of the optical microscope (M).

After the surface of such a member as a semiconductor wafer to which surface a sample is attached was moved to the level of the focus position of an optical microscope (M) by moving a sample stage (not shown in the Figures) of the optical microscope (M) to the direction of Z axis in the state wherein the moving member (15) was held at a waiting position, a search is conducted for a sample such as a dust or foreign substance by moving the sample stage (not shown in Figures) within a plain surface XY. After the sample was moved to the focus position, the sample can be caught with the tip of the sampling needle (23) by moving the moving member (15) from a waiting position to a sampling position so that the tip of the sampling needle (23) is moved to the focus position.

In the sampling apparatus of the present invention, (A06) a member (17) for holding the moving member (15) at a waiting position may be composed of an elastic member which acts on the moving member (15) so as to hold the member always at a waiting position, and to make the movement of the moving member (15) to a sampling position possible at the time when external force was applied to the moving member (15) so as to move the member to the sampling position.

In this case, the holding member (17) described above acts on the moving member (15) so as to hold the member always at a waiting position, and makes the movement of the moving member (15) to a sampling position possible at the time when external force was applied to the moving member (15) so as to move the member to a sampling position.

Accordingly, the moving member (15) is usually held at a waiting position by the holding member (17), and the position of the tip of a sampling needle (23) is apart from the focus position of an optical microscope (M) at this time. A minute sample can readily be caught by moving the sample to the focus position of the optical microscope (M) in that state, and then moving the moving member (15) to a sampling position.

Further, in the sampling apparatus of the present invention,

(A07) a fixed frame may be constructed so as to be attachable to and detachable from a mirror cylinder which supports the object lens of an optical microscope (M).

Thus, in this case, a minute sample can readily be caught even by employing an ordinary optical microscope, specifically speaking, by attaching the sampling apparatus of the present invention to a mirror cylinder of an ordinary optical microscope.

Sampling Method:

In the sampling method of the present invention, a sampling apparatus in which a moving member (15), which supports a sampling needle (23) and is moved integratedly with the sampling needle (23), is adjusted so as to be reciprocatably movable between a waiting position where the position of the tip of the sampling needle (23) is apart from the focus position of an optical microscope (M) and a sampling position where the tip of the sampling needle (23) is situated at the focus position of the optical microscope (M) is used, and the following steps (B01) to (B03) are conducted in order:

(B01) a sample moving step in which preferably both of the surface to which a sample to be inspected or analyzed is attached and the sample stage which supports the surface are moved so that the sample is moved to the focus position of an optical microscope (M),

(B02) a needle moving step in which a moving member (15), which supports a sampling needle (23) and is moved integratedly with the sampling needle (23), is moved from a waiting position where the position of the tip of the sampling needle (23) is apart from the focus position of an optical microscope (M) to a sampling position where the tip of the sampling needle (23) is situated at the focus position of the optical microscope (M), and

(B03) a sampling step in which a sample caught on the tip of the sampling needle (23) is taken away from the surface to which the sample is attached, and then collected.

Thus, a sample can readily be caught according to the sampling method of the present invention.

### EXAMPLES

Now, the present invention will be described in further detail with reference to Examples. However, it should be understood that the scope of the present invention is by no means restricted by such specific Examples and that the present invention includes all the variations and modifications falling within the scope of the appended claims.

In order to facilitate the understanding of the descriptions in the following, back and forth direction in the Figures is assumed to be X axis direction, right and left direction: Y axis direction, and up and down direction: Z axis direction, respectively, and the direction or side indicated by arrow X, -X, Y, -Y, Z, or -Z is assumed to indicate the front, rear, left, right, upper, or lower direction or side, respectively.

Further, the symbol “◯” having “.” therein is intended to indicate an arrow pointing from the back side to the front side of the paper, and the symbol “◯” having “X” therein is to indicate an arrow pointing from the front side to the back side of the paper.

### Example 1

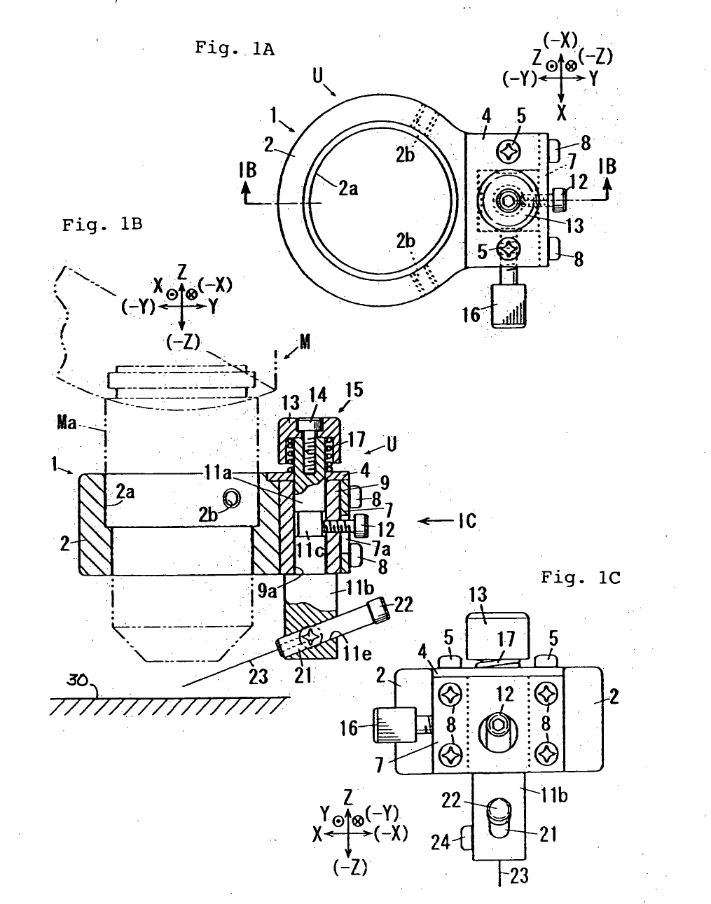

FIGS. 1A to 1C are illustrations of the entire sampling apparatus U of the present invention described in Example 1. FIG. 1A is the plane view of the sampling apparatus, FIG. 1B is the cross-sectional side view of the apparatus taken along line IB-IB in FIG. 1A, and FIG. 1C is the view of the apparatus viewed from the direction of arrow 1C in FIG. 1B.

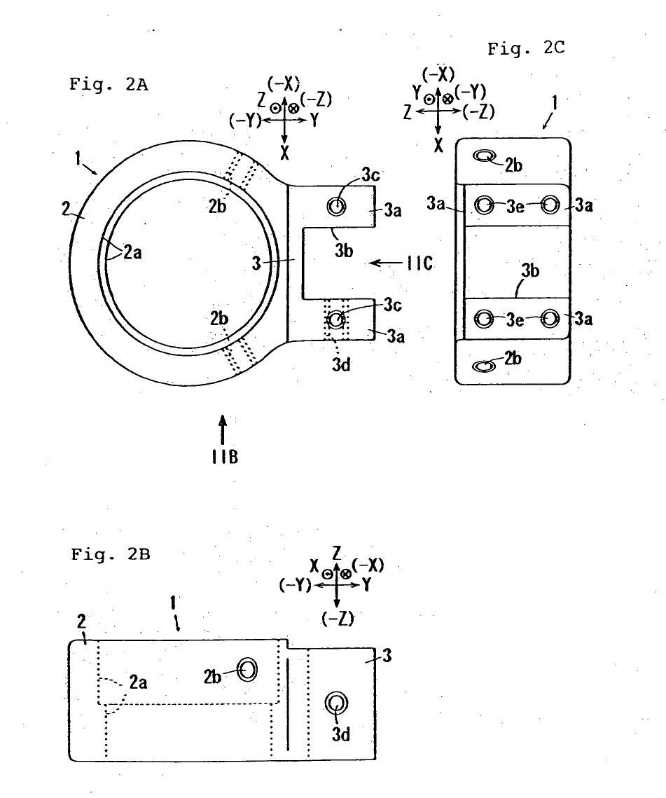

FIGS. 2A to 2C are illustrations of the frame to be fixed in the sampling apparatus U shown in FIG. 1. FIG. 2A is the plane view of the frame, FIG. 2B is the view of the frame viewed from the direction of arrow IIB in FIG. 2A, and FIG. 2C is the view of the frame viewed from the direction of arrow IIC in FIG. 2A.

In FIG. 1B, sampling apparatus U has fixed frame 1, and the frame 1 is a member to be fixed by detachably installing it to the mirror cylinder Ma which admits the object lens (not shown in the Figure) of optical microscope M shown by two dot chain dashes.

In FIGS. 1A to 1C and FIGS. 2A to 2C, frame 1 to be fixed has cylinder portion 2 which has the inner circumferential surface 2a fitting with the outer circumferential surface of the mirror cylinder Ma, and member 3 for equipping a moving member thereto.

In the cylinder portion 2, two screw holes 2b, 2b for fixing frame 1 to mirror cylinder Ma which fits to inner circumferential surface 2a are formed. Frame 1 is detachably fixed to mirror cylinder Ma of optical microscope M shown in FIG. 1B with screws (not shown in the Figure) which are screwed into screw holes 2b, 2b.

Member 3 (see FIG. 2A) for equipping a moving member has a pair of protruded portions 3a, 3a which are protruded to the right side direction from its front and rear positions departed each other, respectively, and U-shaped ditch 3b extending in the up and down direction is formed by the protruded portions 3a, 3a (see FIGS. 2A and 2C). In the upper surface of each of the protruded portions 3a, 3a, screw holes 3c, 3c are formed. Besides, screw hole 3d used for fixing a moving member and extending to the back and forth direction (X axis direction) is formed in the protruded portion 3a positioned at the front side of the member 3. In the right side surface (Y side surface) of each of protruded portion 3a, 3a, a pair of upper and lower screw holes 3e, 3e are formed.

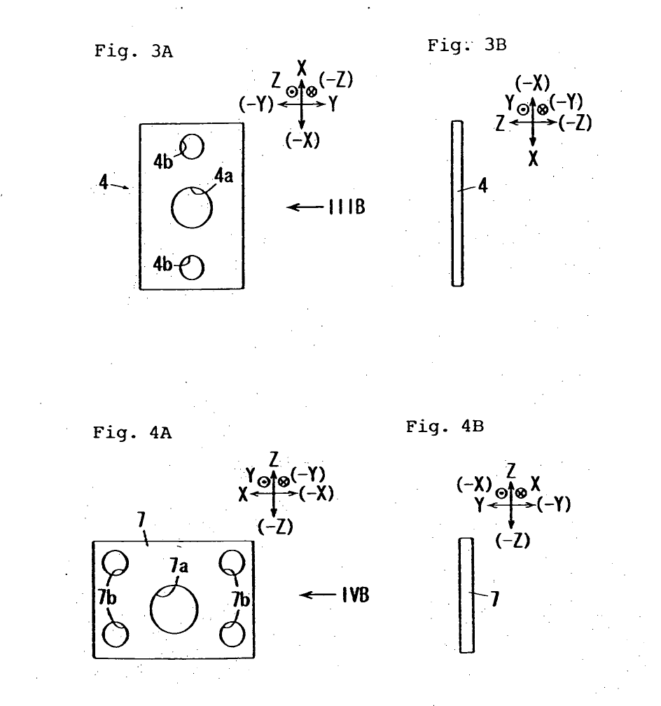

FIGS. 3A and 3B are illustrations of the upper plate of sampling apparatus U. FIG. 3A is the plane view of the plate and FIG. 3B is the view of the plate viewed from the direction of arrow 111B in FIG. 3A.

In FIG. 3A, upper plate 4 is a rectangular metallic plate, shaft through-hole 4a is formed at the center portion of the plate, screw through-holes 4b, 4b are formed at the front and rear side of shaft through-hole 4a, respectively.

In FIGS. 1A to 1C, upper plate 4 is fixed on the upper surface of protruded portions 3a, 3a (see FIG. 2A) with screws 5, 5 (see FIGS. 1A and 1C) which pass through screw through-holes 4b, 4b (see FIG. 3A).

FIGS. 4A and 4B are illustrations of the side plate to be fixed to the right side surface of a pair of protruded portions 3a, 3a of sampling apparatus U. FIG. 4A is the front view of the plate fixed to the right side of the protruded portions and FIG. 4B is the view of the plate viewed from the direction of arrow IVB in FIG. 4A.

In FIGS. 1A to 1C and FIGS. 4A and 4B, side plate 7 is a rectangular metallic plate, screw through-hole 7a is formed at the center portion of the plate, and a pair of upper and lower screw through-holes 7b, 7b are formed at the front side (X side) and rear side (-X side) of screw through-hole 7a, respectively.

In FIGS. 1A to 1C, side plate 7 is fixed to the right side surface of protruded portions 3a, 3a (see FIG. 2A) with screws 8, 8 (see FIGS. 1A to 1C) passing through screw through-holes 7b, 7b (see FIG. 4A). This side plate 7 has blocked the right side end of U-shaped ditch 3b (see FIG. 2A), and has, together with U-shaped ditch 3b, a function of guiding the slider 9 (described above) up and down.

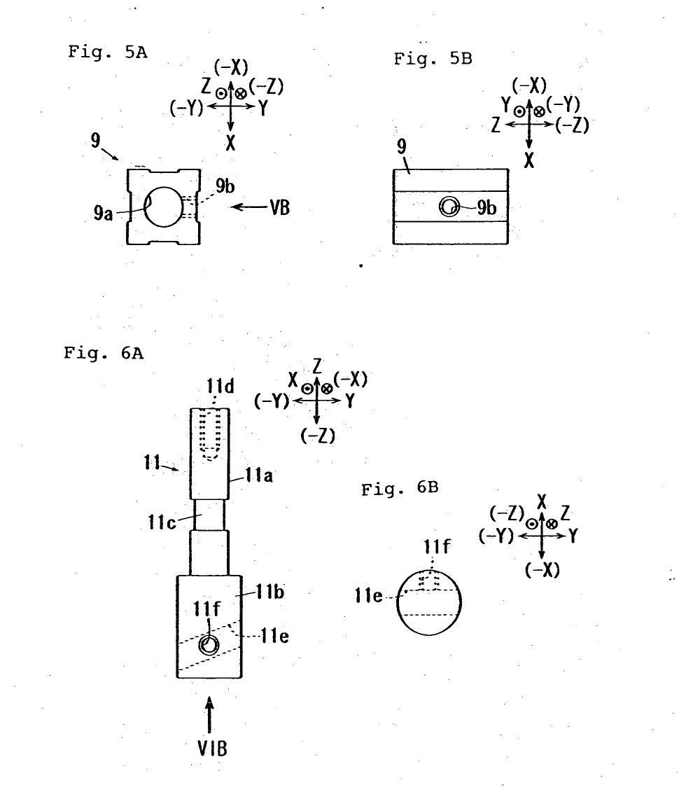

FIGS. 5A and 5B are illustrations of the slider in sampling apparatus U. FIG. 5A is the plane view of the slider and FIG. 5B is the view of the slider viewed from the direction of arrow VB in FIG. 5A.

Shape of slider 9 is about a square in FIG. 5A and rectangular in FIG. 5B, and the slider 9 has shaft guide hole 9a which extends up and down. Besides, hole 9b extending from the right side outside surface to the shaft guide hole 9a and receiving a screw used for connecting a shaft is formed in slider 9. The slider 9 is a member which is supported slidably in the up and down direction by U-shaped ditch 3b of the frame 1 to be fixed (see FIG. 2A).

FIGS. 6A and 6B are illustration of the shaft in sampling apparatus U. FIG. 6A is the front view of the shaft and FIG. 6B is the bottom view of the shaft viewed from the direction of arrow VIB in FIG. 6A.

In FIG. 6A (FIGS. 1B, 1C, and 6B), shaft 11 is a member in a shape of a cylindrical (solid) column. The shaft 11 has a guidable upper portion 11a having a smaller diameter, and a lower portion 11b having a larger diameter and used for supporting a sampling needle. At a middle portion in the up and down direction of the guidable portion 11a, portion 11c which has a still smaller diameter and to which a screw contacts is formed. At the upper end of guidable portion 11a, screw hole lid is formed (see FIG. 6A). In the portion 11b for supporting a sampling needle, hole 11e which passes obliquely through the supporting portion and is used for inserting a holder therein is formed. Besides, in the sampling needle supporting portion 11b, screw hole 11f which extends from the front side outer surface of the supporting portion to the holder inserting hole 11e is formed.

In FIG. 1B, guidable portion 11a is supported by shaft guide hole 9a so as to be rotatable and slidable in the up and down direction. In FIGS. 1A to 1C, connecting screw 12, tip of which contacts with screw contact portion 11c of shaft 11, passes through the screw through-hole 7a (see FIGS. 1B and 4A) and further passes through hole 9b for receiving a screw used for connecting the shaft while being screwed therein (see FIG. 5A). The connecting screw 12 is to connect slider 9 with shaft 11, and the slider 9 and shaft 11 are integratedly connected in the state wherein connecting screw 12 is tightened, and they are moved in the up and down direction along the U-shaped ditch 3b. In the state wherein connecting screw 12 is loosened, shaft 11 is rotatable in shaft guide hole 9a of slider 9, and thus the rotational position of shaft 11 comes to be adjustable.

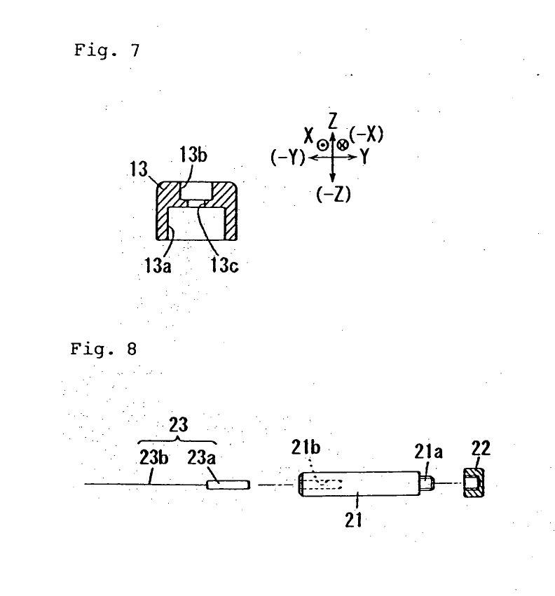

FIG. 7 is a cross-sectional view of a spring case in sampling apparatus U.

In FIGS. 1A to 1C, and FIG. 7, spring case 13 is a cylindrical (hollow) member, cylindrical hollow portion 13a for receiving a spring is formed at the lower side of the member, and hole 13b for receiving the head of a screw is formed at the upper side of the member. Between the cylindrical hollow portion 13a for receiving a spring and hole 13b for receiving the head of a screw, screw through-hole 13c is formed. In FIG. 1B, spring case 13 is fixed to the upper end of shaft 11 with screw 14. Accordingly, in the state wherein slider 9 and shaft 11 were integratedly connected by tightening the connecting screw 12, slider 9, shaft 11, spring case 13, and screws 12 and 14 are integratedly connected and are moved up and down integratedly.

Moving member 15 is constructed by members or parts indicated by numerical symbols 9 to 14.

In this connection, position of moving member 15, which is moved in the up and down direction while being guided by the U-shaped ditch 3b (see FIGS. 2A and 2B), in the up and down direction can be-fixed by tightening slider fixing screw 16 (see FIGS. 1A and 1C) which is screwed into the hole 3d (see FIG. 2A) in the state wherein screw 12 was tightened.

In cylindrical hollow portion 13a of spring case 13, compression spring (elastic member) 17 is received. Lower end of compression spring 17 is in contact with the upper surface of upper plate 4 (see FIG. 1B), and upper end of the spring always acts to force up spring case 13 towards upper direction. At this time, moving member 15 constructed by the members or parts indicated by numerical symbols 9 to 14 is held with the compression spring 17 at a raised position (waiting position).

FIG. 8 is an exploded view of a needle holder and sampling needle.

In FIG. 8, needle holder 21 is composed of a cylindrical metallic rod, male screw 21a is formed on the outer circumferential surface at its base side portion (right side portion in FIG. 8) of the holder, and hole 21b for inserting a needle is formed at the tip side portion (left side portion in FIG. 8) of the holder. Cap-like operating knob 22 has been screwed into the male screw 21a and fixed thereto. Sampling needle 23 to be detachably inserted in the needle inserting hole 21b has insertable cylindrical (solid) column base portion 23a having a large diameter, and tip needle portion 23b. The insertable cylindrical portion 23a is detachably inserted in the needle inserting hole 21b to equip the needle to the needle holder.

Tip of needle portion 23b of sampling needle 23 is placed at a position eccentric by about 1 mm from the center line of the insertable cylindrical portion 23a.

As shown in FIG. 1B, needle holder 21 in which sampling needle 23 was inserted is inserted in holder inserting hole 11e (see FIGS. 6A and 6B) formed in sampling needle supporting portion 11b of moving member 15 so as to pass therethrough and to be slidable to the axial direction. Besides, since the tip of needle portion 23b of the sampling needle 23 is situated at a position eccentric by about 1 mm from the center line of insertable cylindrical portion 23a, the tip of needle portion 23b is moved so as to draw a circle around the center line of needle holder 21 when needle holder 21 was rotated by rotating the operating knob 22. At this time, since the position of the tip of needle portion 23b is varied in the range of about 2 mm to the vertical and horizontal directions, it is possible to adjust the position of the tip of needle portion 23b within the range of about 2 mm in the direction of optical axis of optical microscope M.

Position of the tip of needle portion 23b can roughly be adjusted in the direction of optical axis of the object lens of optical microscope M by causing needle holder 21 to slide in holder inserting hole 11e (see FIGS. 6A and 6B), with operating knob 22. Also, the position of the tip of the needle portion 23b in the direction of optical axis of the object lens of optical microscope M can minutely be adjusted by rotating needle holder 21 around its axis with operating knob 22. When the minute adjustment is conducted, the tip of needle portion 23b is usually moved even in the direction perpendicular to that of the optical axis, at the same time with the adjustment of the position in the direction of the optical axis of the object lens of optical microscope M (direction of axial line of shaft 11). However, in order to move the tip of needle portion 23b within a plane perpendicular to the optical axis without moving to the direction of the optical axis, it is sufficient to rotate operating knob 22 around shaft 11 in the state wherein the connecting screw 12 is loosened. At that time, the tip of needle portion 23b is rotated around the axial line of shaft 11 together with shaft 11, and adjustment of the position within a plane perpendicular to the optical axis is performed.

Needle position adjusting device, which can adjust the position of sampling needle 23 relative to the moving member 15, is constructed by the members or parts indicated by symbols 11e, 21, 22 so that the tip of sampling needle 23 is situated at the focus position of the object lens of optical microscope M in the state wherein the moving member 15 was moved to a sampling position.

Needle holder 21 position of which was adjusted as described above can be fixed to sampling needle supporting portion 11b of the moving member 15 with fixing screw 24 (see FIG. 1C).

Sampling needle fixing means, which fixes the sampling needle 23 to the moving member 15 in the state wherein the position of the sampling needle 23 relative to the moving member 15 is adjusted so that the tip of the sampling needle 23 is situated at the focus position of the object lens of optical microscope M, is composed of screw 24.

(Function of the Apparatus of Example 1)

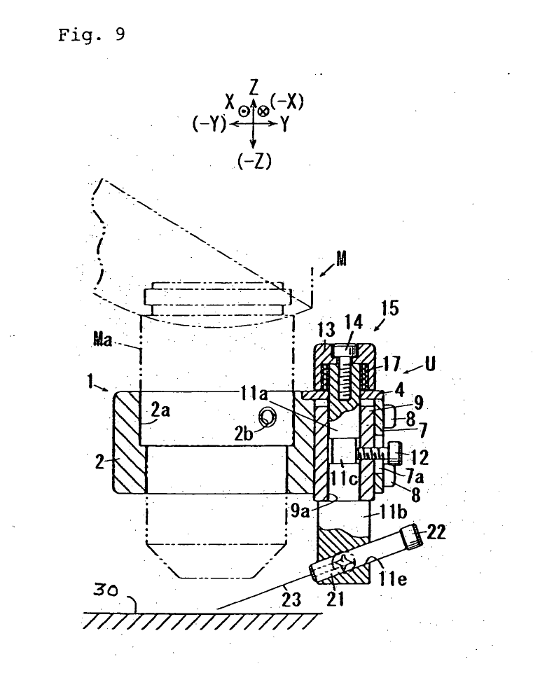

With respect to sampling apparatus U of the present invention described in Example 1, FIG. 9 is a view showing the state wherein a moving member was moved from the position shown in FIG. 1B to a lower position.

FIG. 1B mentioned above shows the state wherein the tip of sampling needle 23 is moved to a waiting position apart from the focus position of optical microscope M, and FIG. 9 shows the state wherein spring case 13 was pushed downward to move moving member 15 composed of the members or parts indicated by symbols 9 to 14 described above to a lower position (position where the lower end of spring case 13 contacts with the upper surface of upper plate 4, that is, a sampling position). As shown in FIG. 1B and FIG. 9, moving member 15 reciprocates between the waiting position and the sampling position described above.

In order that the tip of sampling needle 23 moves to the focus position of optical microscope M when the moving member was moved from the state shown in FIG. 1B to the state shown in FIG. 9, the following adjustment is performed. In this connection, when the following adjustment is performed, the connecting screw 12 is kept in a loosened state to hold shaft 11 in a rotatable condition relative to slider 9.

When the spring case 13 was pushed down to make it in the state shown in FIG. 9 and the screw 16 (see FIGS. 1A and 1C) for fixing slider 9 was tightened, slider 9 is fixed at the position shown in FIG. 9. In this state, as shown in FIG. 9, the upper end of sampling needle supporting, member 11b of shaft 11 to which a force is applied toward upward direction by compression spring 17 is held in the state wherein the upper end of the member 11b contacts with the lower end of slider 9.

In the state shown in FIG. 9, the position of the tip of sampling needle 23 is moved in the vicinity of the focus position of optical microscope M by sliding needle holder 21 with operating knob 22. At that position, when needle holder 21 was rotated around its axial line with operating knob 22, the tip of sampling needle 23 is moved in the up and down direction (direction of optical axis of the object lens of optical microscope M) and moved even to the direction perpendicular to the optical axis at the same time since the position of the tip of sampling needle 23 is eccentric from the axial line. Since the tip of sampling needle 23 tends to move outside the visual field of optical microscope M at this time, the needle holder 21 is rotated and shaft 11 is rotated at the same time with the operating knob 22 in order that the tip does not move outside the visual field.

Accordingly, the tip of sampling needle 23 can be moved to the focus position of optical microscope M by conducting both of the operation of sliding in the direction of axial line and rotating around the axial line of needle holder 21 with the operating knob 22, and the operation of rotating the shaft 11 at the same time. In the state wherein the tip of sampling needle 23 was moved to the focus position of optical microscope M, slider 9 and shaft 11 are integratedly connected by tightening the connecting screw 12, and needle holder 21 position of which in sampling needle supporting portion 11b of the moving member 15 was adjusted is fixed with fixing screw 24 (see FIG. 1C) at the same time.

At this time, the members or parts shown by numerical symbols 9 to 14 which form moving member 15 are integratedly connected, and needle holder 21 is fixed to sampling needle supporting portion 11b of moving member 15 in the state wherein the position of the holder is adjusted. Tip of sampling needle 23 fixed to the needle holder 21 is held at the focus position of optical microscope M.

That is, moving member 15 at this time is in the state wherein the tip of sampling needle 23 is moved to a sampling position where the tip of the needle is situated at the focus position of optical microscope M.

In this state (shown in FIG. 9), when the slider fixing screw 16 was loosened, moving member 15 rises to move a waiting position shown in FIG. 1B (position where the tip of sampling needle 23 is apart from the focus position of optical microscope M).

In this state, when a semiconductor wafer or the like (a member to which a sample such as a dust or foreign substance which is necessary to be inspected or analyzed might be attached) was supported on a sample stage (not shown in Figures) of optical microscope M, the surface of the member such as a semiconductor wafer was observed while the sample stage (not shown in Figures) being moved, and a sample such as a dust or foreign substance was found at the focus position, the sample such as a dust or foreign substance can be caught with the tip of sampling needle 23 by moving the moving member 15 from a waiting position shown in FIG. 1B to the sampling position shown in FIG. 9 and contacting the tip to or bringing it near to the sample. Specifically, the sample can be caught with the tip, for example, by the action of static electricity or by thrusting the tip into the sample. Also, the sample can be caught by scooping or ladling the sample with the tip of sampling needle 23. Sample caught by the tip of the sampling needle 23 can be collected by raising moving member 15 to a waiting position shown in FIG. 1B.

Sample collected by such procedures is subjected to a detail observation, inspection, or analysis by using a high magnification of an optical microscope, electron microscope, infrared microscope, or the like.

As will be understood from the recital of function of the sampling apparatus of Example 1 described above, when the surface of a member such as a semiconductor wafer or the like to which a sample might be attached (that is, the surface of a member to which a sample such a dust or foreign substance, which should be inspected, might be attached) supported on a sample stage (not shown in Figures) was observed through optical microscope M in the state wherein moving member 15 of sampling apparatus U was held in the waiting position shown in FIG. 1B, and the sample was found, the sample can be collected only by pushing down spring case 13 to move moving member 15 to a lower sampling position and then raising the member to a waiting position. That is, a sample such as a dust or foreign substance moved to the focus position of optical microscope M can simply be collected only by reciprocating moving member 15 at a waiting position (see FIG. 1B) between the waiting position and a sampling position (see FIG. 9).

When it was unable to collect the sample (dust or foreign substance) only by the reciprocation of the moving member 15, the sample can be collected by moving the sample (dust or foreign substance) toward the tip of sampling needle 23 in the state wherein moving member 15 was moved to a sampling position so that the sampling needle is pushed or thrust into the sample, or that the sample is weakly and temporarily attached to the sampling needle, by moving a sample stage (not shown in Figures), and then raising the moving member 15 up to a waiting position (see FIG. 1B).

### Example 2

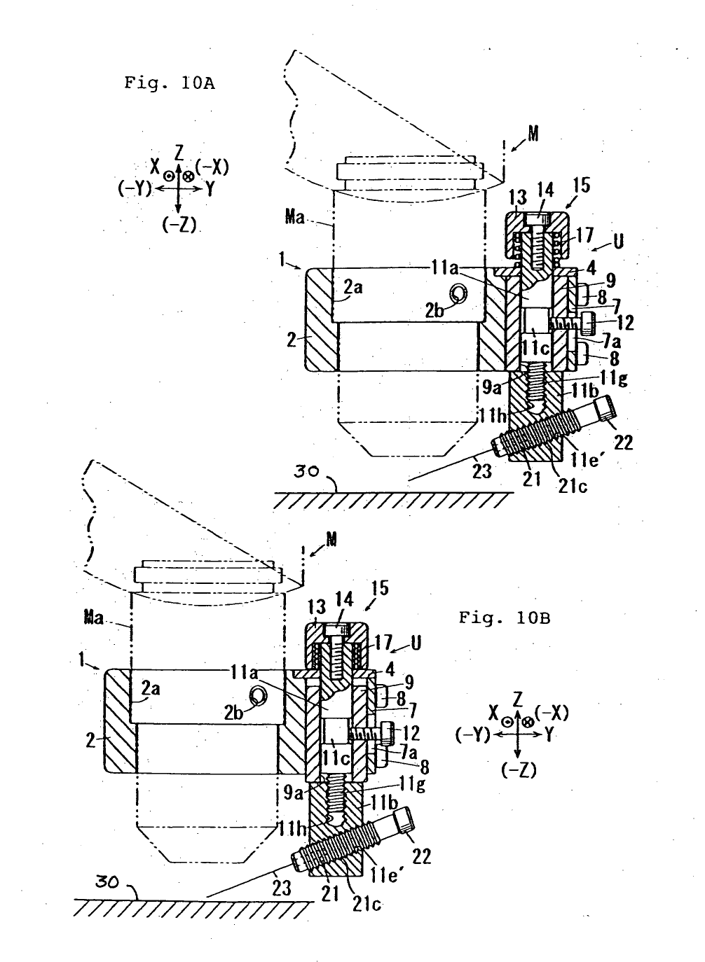

FIGS. 10A and 10B are illustrations of sampling apparatus U of the present invention described in Example 2. FIG. 10A is a view showing the state wherein moving member 15 of sampling apparatus U is held at a waiting position and FIG. 10B is a view showing the state wherein the moving member 15 was moved to a sampling position.

(In the descriptions of the sampling apparatus in Example 2, the same referential symbol as that in Example 1 is added to a member or portion corresponding to the member or portion in Example 1, and thus detailed explanations thereof are omitted.)

Shaft 11 is constructed in such a way that guidable portion 11a and sampling needle supporting portion 1b are separate structural parts. At the lower end of guidable portion 11a, male screw 11g which extends downward is provided, and at the upper end of sampling needle supporting portion 11b, screw hole 11h in which the male screw is screwed in is formed. Besides, in the sampling needle supporting portion 11b, screw hole 11e′ for inserting a holder therein is formed instead of holder inserting hole 11e (see FIG. 6).

Further, on the outer circumferential surface of needle holder 21 in the apparatus of Example 2, male screw 21c which is screwed into the screw hole 11e′ is formed. In Example 2, sampling needle 23 is situated on the center line of screw hole 11e′ used for equipping a holder therein.

In other respects, the apparatus of Example 2 is constructed in the same way as that of Example 1.

(Function of the Apparatus of Example 2)

In the state shown in FIG. 10B, the apparatus is adjusted by the operations (1) to (5) described below, under the conditions wherein screw 16 for fixing a slider (see FIGS. 1A and 1C) was tightened to fix the slider, and shaft connecting screw 12 and screw 24 (see FIG. 1C) for fixing a holder of a sampling needle were loosened, so that the tip of sampling needle 23 is situated at the focus position of the object lens (not shown in Figures) of optical microscope M.

At the time of the adjustment, a sample stage (not shown in Figures) of optical microscope M is moved downward and held at that position.

(1) Position of needle holder 21 is adjusted to such an extent that the tip of sampling needle 23 reaches the focus position by moving the needle 23 in the direction of the axis of screw hole 11e′ used for equipping a needle holder therein, by rotating operating knob 22.

(2) When sampling needle supporting portion 11b was grasped by one hand so that the portion is not rotated and spring case 13 was rotated by the other hand, sampling needle supporting portion 11b is moved up and down. When spring case 13 was rotated without grasping sampling needle supporting portion 11b with one hand, the sampling needle supporting portion 11b rotates together with spring case 13. Accordingly, it is possible to control the movement of the tip of sampling needle 23 so that the tip of the needle passes through the focus position by adjusting the position in the up and down direction and rotational position of the sampling needle supporting portion 11b. In that state, connecting screw 12 is tightened to integratedly connect slider 9 with shaft 11.

(3) In that state, sampling needle 23 is moved in the axial direction of screw hole 11e′ used for equipping a holder by rotating operating knob 22 so that the tip of sampling needle 23 is moved to the focus position. In this state, screw 24 for fixing a holder is tightened to fix needle holder 21 to sampling needle supporting portion 11b. Position of moving member 15 at this time (position shown in FIG. 10B) is a sampling position where the tip of sampling needle 23 is kept at the focus position.

(4) In that state, when the screw 16 used for fixing a slider was loosened, moving member 15 is moved to a waiting position shown in FIG. 10A.

(5) In the state wherein moving member 15 was moved to a waiting position shown in FIG. 10A, when a sample stage (not shown in Figures) was moved in Z axis direction so that the surface of a member such as a semiconductor wafer to which a sample is attached was moved to the level of the focus position and then the sample stage (not shown in Figures) was moved within XY plane-surface so that such a sample as a dust or foreign substance was moved to the focus position, a sample can be caught in the same way as that in Example 1 by moving the moving member 15 from a waiting position shown in FIG. 10A to a sampling position shown in FIG. 10B.

### Example 3

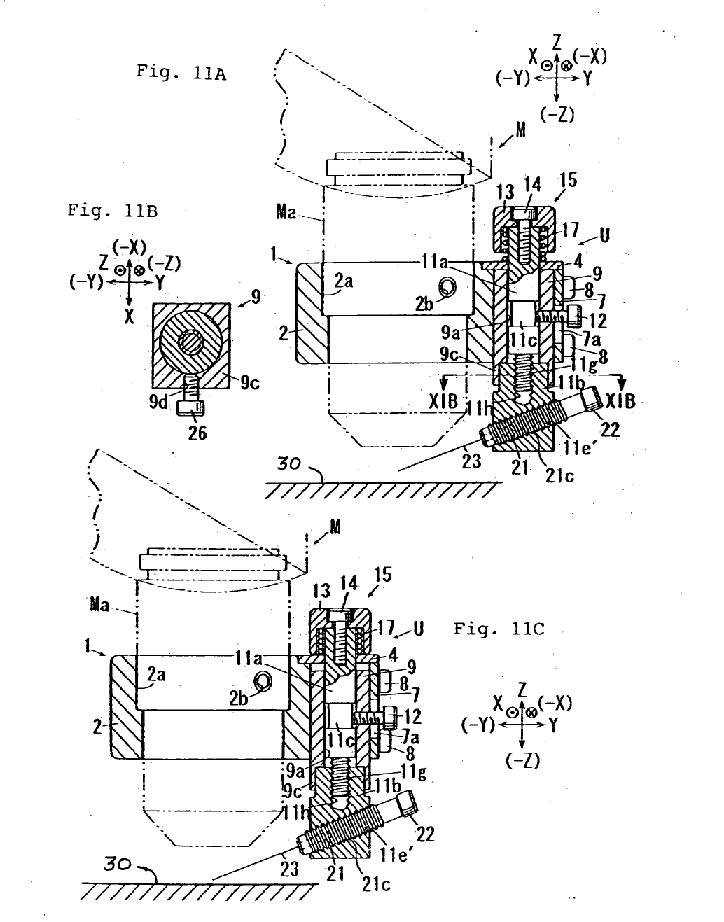

FIGS. 11A and 11C are illustrations of sampling apparatus U of the present invention described in Example 3. FIG. 11A is a view showing the state wherein moving member 15 of sampling apparatus U is held at a waiting position, and FIG. 11C is a view showing the state wherein the moving member 15 was moved to a sampling position. FIG. 11B is the cross-sectional view of an important part of the moving member described in Example 3 taken along the line XIB-XIB in FIG. 11A,

(In the descriptions of the sampling apparatus in Example 3, the same referential symbol as that in Example 2 is added to a member or portion corresponding to the member or portion in Example 2, and thus detailed explanations thereof are omitted.)

In FIGS. 11A and 11C, at the lower end portion of slider 9, guide cylinder 9c having a square outer circumferential surface and a circular (cylindroid) inner surface is formed, and screw hole 9d is formed in the guide cylinder 9c. Besides, at the upper end portion of sampling needle supporting portion 11b, an insert portion having a cylindrical outer circumferential surface which fits with the inner circumferential surface of the guide cylinder 9c is formed.

In the state wherein screw 26 which is screwed into screw hole 9d and passes therethrough is loosened, sampling needle supporting portion 11b is rotatable relative to slider 9. However, in the state wherein the screw 26 was tightened, sampling needle supporting portion 11b is unrotatable relative to slider 9 and is moved integratedly with slider 9.

In other respects, the apparatus of Example 3 is constructed in the same way as that of Example 1.

(Function of the Apparatus of Example 3)

In the apparatus of Example 3, rotation and sliding of sampling needle supporting portion 11b are stable since the insert portion at the upper end portion of the sampling needle supporting portion 11b is guided in rotational direction and sliding direction by guide cylinder 9c at the lower end portion of slider 9. Also, sampling needle supporting portion 11b can surely be fixed to slider 9 with screw 26.

Other functions of the apparatus of Example 3 are the same as in Example 2.

Modified Example

Examples of the present invention are described above in detail. However, the present invention is not restricted to the specific Examples described above, and variations and modifications can be performed within the scope of the appended claims. Thus, modified examples of the present invention are exemplified as follows:

(H01) In each of the apparatus of the Examples described above, as a member for holding a moving member at a waiting position, any member can be used so far as the member has a function of holding a moving member moved to a waiting position at the waiting position. For example, a screw which fixes a moving member at a waiting position can be used as waiting position holding member.

(H02) Whereas a fixed frame is constructed so as to be attachable to and detachable from a mirror cylinder of an optical microscope in each of the apparatus of the Examples described above, it is possible to construct the frame, to be fixed, integratedly with a mirror cylinder. An optical microscope in this case has a function as sampling apparatus from the outset. However, this optical microscope having a function as sampling apparatus is simple in its structure and can be manufactured at a low cost compared with conventional ones.

(H03) In each of the apparatus of the Examples described above, a frame which is fixed at a prescribed position relative to the object lens of an optical microscope is not necessary to be fixed to a mirror cylinder which supports the object lens in the following cases (a) and (b), and the frame can be fixed to any member so far as the member has been fixed to the object lens:

(a) Optical microscope M is used on the premise, for instance, that only a sample stage is moved within the space of XYZ and that a mirror cylinder is not moved in the direction of its optical axis.

(b) For example, optical microscope M in which the object lens is not moved in the direction of optical axis is manufactured, and used in combination with a sampling apparatus.

(H04) In the apparatus of the present invention, reciprocation of moving member 15 between a waiting position and a sampling position can be performed through an automatic operation by using a driving member such as a motor or solenoid, instead of manual operation.

Sampling apparatus and sampling method of the present invention achieve the following effects (E01) to (E03):

(E01) Minute sample for microscopic analysis can readily be collected.

(E02) It is possible to provide a sampling apparatus which is simple in its structure and can be manufactured at a low cost, and to provide a sampling method in which operations are simple.

(E03) It is possible to provide a sampling apparatus which can be used by installing detachably to an ordinary microscope.

1-4. Cancelled.

5. A sampling method using an optical microscope having an object lens comprising:
a first needle moving step in which a moving member, which supports a sampling needle, is moved from a sampling position where the tip of the sampling needle is situated at a focus position of the object lens to a waiting position where a position of a tip of the sampling needle is spaced from the focus position of the object lens.
a second needle moving step in which the moving member, which supports the sampling needle, is moved from a waiting position where a position of the tip of the sampling needle is spaced from the focus position of the object lens to a sampling position where the tip of the sampling needle is situated at the focus position of the object lens,
a sample moving step in which a surface of a sample stage on which a sample is located is moved to the focus position so that a sample is observed at the focus position, and
a sample pick up step in which the sample is caught and held on the tip of the sampling needle and moved away from the surface on which the sample is located by using a sampling apparatus in which the moving member is adjustable so as to be reciprocatably movable between a waiting position where the position of the tip of the sampling needle is spaced from the focus position of the object lens and a sampling position where the tip of the sampling needle is situated at the focus position of the object lens whereby said sample may be analyzed.

6. A sampling apparatus comprising:
an optical microscope having an object lens;
a frame fixed at a prescribed position relative to said object lens of said optical microscope,
a moving member supported by said fixed frame so as to be reciprocatably movable between a sampling position and a waiting position,
a member for holding said moving member at the waiting position,
a sampling needle supported by said moving member,
a device for adjusting a position of said sampling needle relative to said moving member so that a tip of said sampling needle is situated at a focus position of an object lens of said optical microscope in a state wherein said moving member is moved to the sampling position,
means for mounting said sampling needle to said moving member whereby a position of said sampling needle relative to said moving member is adjusted so that the tip of said sampling needle is situated at the focus position of the object lens of said optical microscope, and
means for moving a surface on which a sample is located.

7. A sampling apparatus according to claim 6 which further includes means for holding said moving member at the waiting position, said means for holding said moving member comprising an elastic member which acts on said moving member so as to hold said moving member at the waiting position and to enable movement of said moving member to the sampling position when an external force is applied to said moving member so as to move said moving member to the sampling position.

8. A sampling apparatus according to claim 6 which further includes a mirror cylinder which supports said object lens of said optical microscope.
